(19) United States
(12) Patent Application Publication
(10) Pub. No.: US 2016/0341820 A1
(43) Pub. Date: Nov. 24, 2016

(54) HYBRID WIRLESS TAG BASED COMMUNICATION, SYSTEM AND APPLICAITONS

(71) Applicant: Pixie Technology Inc., Los Altos, CA (US)

(72) Inventors: Ofer Friedman, Ganei-Tikva (IL); Tsach Shwartz, Ramat Gan (IL); Gili Elias, Herzliya (IL)

(21) Appl. No.: 15/157,523

(22) Filed: May 18, 2016

Related U.S. Application Data
(60) Provisional application No. 62/164,661, filed on May 21, 2015.

(51) Int. Cl. G01S 11/02

(52) U.S. Cl. CPC G01S 11/02

(57) ABSTRACT

Method for determining a distance between a first wireless transceiver of a first device and a second wireless transceiver of a second device, the method may include sending, by the first wireless transceiver and to the second wireless transceiver, (i) a first wideband message that consists essentially of a first synchronization preamble and (ii) a first narrowband message that may include first ranging information and does not include the first synchronization preamble; receiving, by the first wireless transceiver and from the second wireless transceiver, (i) a second wideband message that consists essentially of a second synchronization preamble and (ii) a second narrowband message that may include second ranging information and does not include the second synchronization preamble; and calculating, by the first device and based on portions of the first and second ranging information, a first estimate of the distance between the first wireless transceiver and the second wireless transceiver.

### RELATED APPLICATIONS

This application claims priority from U.S. provisional patent Ser. No. 62/164,661 filing date May 21, 2015, which is being incorporated herein by reference in its entirety.

### FIELD OF THE INVENTION

The invention relates to wireless communication.

### BACKGROUND OF THE INVENTION

There is a growing need to determine the distance between wireless transceivers in an efficient manner.

### SUMMARY OF THE INVENTION

According to various embodiments of the invention there are provided various methods, systems, wireless tags, wireless readers, and non-transitory computerized media.

According to an embodiment of the invention there may be provided a method for determining a distance between a first wireless transceiver of a first device and a second wireless transceiver of a second device, the method may include sending, by the first wireless transceiver and to the second wireless transceiver, (i) a first wideband message that consists essentially of a first synchronization preamble and (ii) a first narrowband message that may include first ranging information and does not include the first synchronization preamble; receiving, by the first wireless transceiver and from the second wireless transceiver, (i) a second wideband message that consists essentially of a second synchronization preamble and (ii) a second narrowband message that may include second ranging information and does not include the second synchronization preamble; and calculating, by the first device and based on portions of the first and second ranging information, a first estimate of the distance between the first wireless transceiver and the second wireless transceiver.

The method wherein the second ranging information may include information about a first time gap between (i) a time of reception, by the second wireless transceiver, of the first wideband message and, (ii) a time of transmission of the second wideband message.

The method may include sending, by the first wireless transceiver and to the second wireless transceiver, (i) a third wideband message that consists essentially of the first synchronization preamble and (ii) a third narrowband message that may include third ranging information and does not include the first synchronization preamble.

The third ranging information may include information about a second time gap between (i) a time of reception, by the first wireless transceiver, of the second wideband message and, (ii) a time of transmission of the third wideband message.

The method may include receiving, by the first wireless transceiver and from the second wireless transceiver, (i) a fourth wideband message that consists essentially of the second synchronization preamble and (ii) a fourth narrowband message that may include a second estimate of the distance between the first wireless transceiver and the second wireless transceiver; wherein the second estimate was calculated by the second device.

The method may include calculating, by the first device and in response to the first and second estimates, a third estimate of the distance between the first wireless transceiver and the second wireless transceiver.

The method may include sending, by the first wireless transceiver and to the second wireless transceiver, (i) a fifth wideband message that consists essentially of the first synchronization preamble and (ii) a fifth narrowband message that may include a first estimate of the distance between the first wireless transceiver and the second wireless transceiver.

The first device may be a wireless tag reader and the second device may be a wireless tag.

The sending of the first wideband message and of the first narrowband message may be preceded by receiving by the first and second wireless devices information about a timing of a ranging time window that is allocated to the sending of the first wideband message, the first narrowband message, the second wideband message and the second narrowband message.

The method wherein the sending of the first wideband message and of the first narrowband message may be preceded by receiving content information that describes a content of the second synchronization preamble; and ignoring the second narrowband message when the second synchronization preamble has a content that differs from the content described in the content information.

The first and second ranging information may include an identifier of the first device and an identifier of the second device.

The first and second synchronization messages may be equal to each other or may differ from each other.

The first and second wideband messages may be conveyed over ultra wideband carriers.

The sending of the first wideband message and of the first narrowband message may be preceded by receiving, by the first and second wireless devices, information about a timing of one or more ranging time windows that are allocated to an execution of one or more ranging process; wherein the execution of the one or more ranging processes may include the sending of the first wideband message, the first narrowband message, the second wideband message and the second narrowband message.

The method may include closing a wideband reception circuit of the first wireless transceiver outside the one or more ranging time windows.

The first wideband message may be transmitted over a wideband channel; wherein the first wideband message has an average energy level that exceeds an average energy obtained when sending both the first wideband message and the first ranging information over the wideband channel

The sending of the first wideband and the first narrowband message may increase a coverage range of the first wireless transceiver.

According to an embodiment of the invention there may be provided a non-transitory computer readable medium that stores instructions that when executed by a first device cause the first device to execute the stages of sending, by a first wireless transceiver of the first device and to a second wireless transceiver, (i) a first wideband message that consists essentially of a first synchronization preamble and (ii) a first narrowband message that may include first ranging information and does not include the first synchronization preamble; receiving, by the first wireless transceiver and from the second wireless transceiver, (i) a second wideband message that consists essentially of a second synchronization preamble and (ii) a second narrowband message that may include second ranging information and does not include the second synchronization preamble; and calculating, by the first device and based on portions of the first and second ranging information, a first estimate of the distance between the first wireless transceiver and the second wireless transceiver.

According to an embodiment of the invention there may be provided a wireless tag that may include a first wireless transceiver and a processor; wherein the first wireless transceiver is configured to send to the second wireless transceiver (i) a first wideband message that consists essentially of a first synchronization preamble and (ii) a first narrowband message that may include first ranging information and does not include the first synchronization preamble; receive from the second wireless transceiver, (i) a second wideband message that consists essentially of a second synchronization preamble and (ii) a second narrowband message that may include second ranging information and does not include the second synchronization preamble; and wherein the processor is configured to calculate, based on portions of the first and second ranging information, a first estimate of the distance between the first wireless transceiver and the second wireless transceiver.

### BRIEF DESCRIPTION OF THE DRAWINGS

The foregoing and other objects, features, and advantages of the present invention will become more apparent from the following detailed description when taken in conjunction with the accompanying drawings. In the drawings, similar reference characters denote similar elements throughout the different views, in which:

FIG. 1 illustrates a method according to an embodiment of the invention;

FIG. 2 illustrates a method according to an embodiment of the invention;

FIG. 3 illustrates a timing diagram according to an embodiment of the invention;

FIG. 4 illustrates a timing diagram according to an embodiment of the invention;

FIG. 5 illustrates various data structures according to an embodiment of the invention; and

FIG. 6 illustrates the first and second devices according to an embodiment of the invention.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system, device, apparatus, wireless tag, or wireless reader capable of executing the method and should be applied mutatis mutandis to a non-transitory computer readable medium that stores instructions that once executed by a computer result in the execution of the method.

Any reference in the specification to a system, device, apparatus, wireless tag, or wireless reader should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to system, device, apparatus, wireless tag, or wireless reader capable of executing the instructions stored in the non-transitory computer readable medium and should be applied mutatis mutandis to method that may be executed by a computer that reads the instructions stored in the non-transitory computer readable medium.

Any combination of any methods disclosed in any of the figures (or anywhere in the specification including the summary) may be provided. Any combination of any stages of such methods may be provided.

A system, device, apparatus, wireless tag, or wireless reader capable of performing any method, any combination of any methods disclosed in any of the figures (or anywhere in the specification) or any stages of such methods may be provided.

A non-transitory computer readable medium that stores instructions that once executed cause a computer to execute any method, any combination of methods disclosed in any of the figures (or anywhere in the specification) or any stages of such methods may be provided.

The terms “computer”, “processor”, “controller” are used in an interchangeable manner

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “processing”, “calculating”, “computing”, “determining”, “generating”, “setting”, “configuring”, “selecting”, “defining”, or the like, include action and/or processes of a computer that manipulate and/or transform data into other data, said data represented as physical quantities, e.g. such as electronic quantities, and/or said data representing the physical objects. The terms “computer”, “processor”, and “controller” should be expansively construed to cover any kind of electronic device with data processing capabilities, including, by way of non-limiting example, a personal computer, a server, a computing system, a communication device, a processor (e.g. digital signal processor (DSP), a microcontroller, a field programmable gate array (FPGA), an application specific integrated circuit (ASIC), etc.), any other electronic computing device, and or any combination thereof.

The operations in accordance with the teachings herein may be performed by a computer specially constructed for the desired purposes or by a general purpose computer specially configured for the desired purpose by a computer program stored in a computer readable storage medium.

The terms “tag” and “wireless tag” are used in an interchangeable manner A tag is a device that includes a wireless transceiver. A tag can include a processor for calculating distances between the tag to other radiating elements (for example—other radiating elements). Alternatively—the tag does not preform distance calculations. A wireless tag may be compact and his length may not exceed few centimeters.

The terms “reader” and “wireless reader” are used in an interchangeable manner A reader is a device that can manipulate (control, program) a wireless tag. A reader can include a transceiver, a reader may perform distance calculations and the like.

The term narrowband refers to a channel in which the bandwidth of the message does not significantly exceed the channel's coherence bandwidth.

The term wideband (or wideband channel) refers to a channel in which the bandwidth of the message significantly exceeds the channel's coherence bandwidth.

The term ultra wideband may refer to an antenna transmission for which emitted signal bandwidth exceeds the lesser of 500 MHz or 20% of fractional bandwidth.

Various examples of wireless tags, methods for operating tags and the like are illustrated in US patent application 2014/0145831 titled HYBRID WIRLESS TAG BASED COMMUNICATION, SYSTEM AND APPLICATIONS, attorney reference 8362-US, which is incorporated herein by reference.

In wideband communication and especially in ultra wideband communication the regulatory constraints are imposed on average (over time) of the transmitted power.

Using the wideband channel for conveying the synchronization preamble while conveying ranging information over a narrowband channel—reduces the average power transmitted over the wideband channel.

Alternatively—using shorter wideband messages (consisting essentially of a synchronization preamble) allows increasing the peak power of the wideband messages while maintaining the same average power.

The phrase “consisting essentially of” means that the wideband message includes the synchronization preamble and may also include items that differ from the synchronization preamble that do not materially affect the basic and novel properties of the invention. For example—the wideband messages may not include at least one out of (a) an identifier of the first device, (b) an identifier of the second device, (c) a request (or command) that is aimed to the second wireless device to participate in the ranging process, (d) timing information such as Tx1, Tr1, Tgap1, Tgap2 and the like.

The increment of the peak power increase the transmission range of the wideband messages and thus allows wireless devices that are more distance from each other—to communicate with each other.

For example, in a standard ultra wideband packet the data portion (ranging information) could take more than half of the overall length. Once the data portion (ranging information) is not conveyed over the ultra wideband channel, the peak power could be increased by more than ×2 (3 dB) while still maintaining the same average output power. Same effect would be achieved if we would use a longer synchronization preamble instead of the data bytes of the data portion. Increasing the peak power (or use longer preamble) leads to better link merging and larger distance that can be supported between nodes while still meeting the regulation output power constrains.

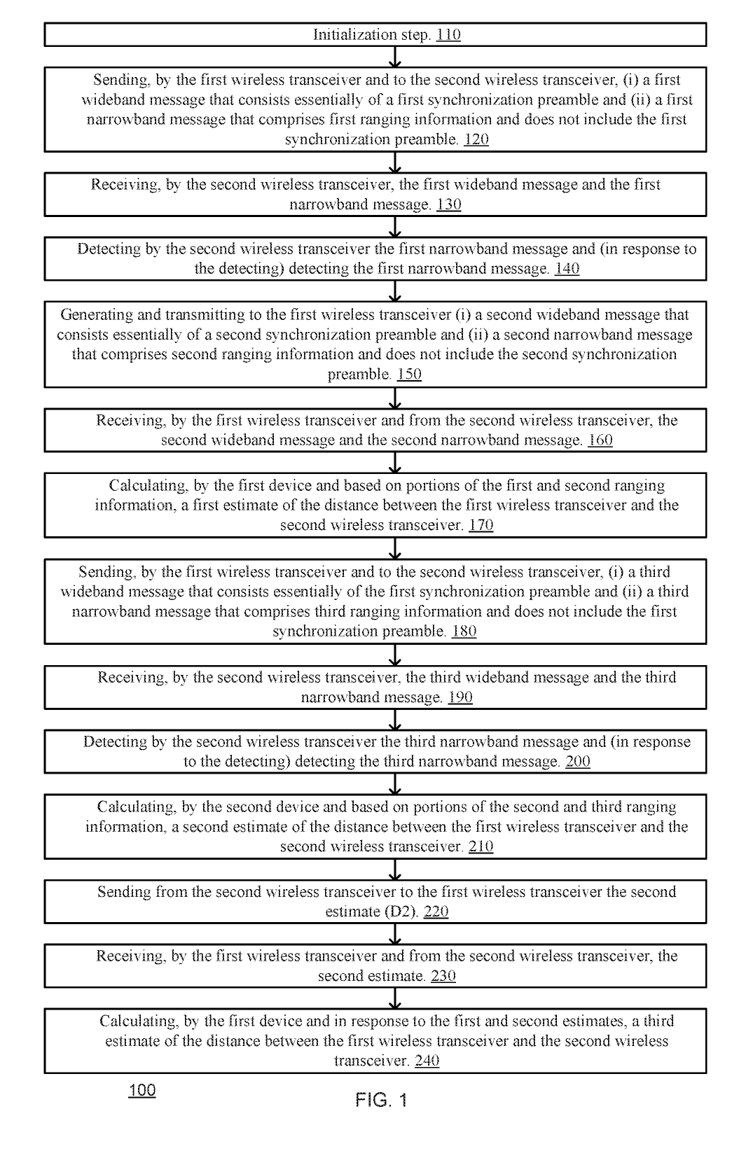

FIG. 1 illustrates method 100 according to an embodiment of the invention.

Method 100 may start by initialization step 110. During the initialization step a first device and/or a second device may receive and/or generate information that may facilitate a ranging process during which the distance between the first and second devices (especially first and second wireless transceivers of the first and second devices).

Step 110 may include receiving by the first and second wireless devices information about timing of a ranging time window that is allocated to an execution of a ranging process for determining the distance between the first and second devices.

Step 110 may include receiving content information that describes a content of the second synchronization preamble. Different groups of device may be associated with different synchronization preambles. A device that belongs to a group of devices that is assigned to a certain synchronization preamble may ignore messages (wideband and/or narrowband messages) that are associated with another synchronization preamble.

The assignment of the synchronization preamble to the groups of devices may be done in a random manner, a pseudo-random manner or in any manner.

Step 110 may include receiving, by the first and second wireless devices, information about a timing of one or more ranging time windows that are allocated to an execution of one or more ranging process; wherein the execution of the one or more ranging processes comprises the sending of the first wideband message, the first narrowband message, the second wideband message and the second narrowband message.

The timing information may be determined by the first device, by the second device, by a controller that does not belong to the first or second device, may be determined in a distributed manner by devices that share the same medium, and the like.

Step 110 may be followed by step 120 of sending, by the first wireless transceiver and to the second wireless transceiver, (i) a first wideband message that consists essentially of a first synchronization preamble and (ii) a first narrowband message that comprises first ranging information and does not include the first synchronization preamble.

The first wideband message and the first narrowband messages may be transmitted simultaneously, in a partially overlapping manner or in proximity to each other. The time gap that is considered to be proximate may be predefined and may be, for example, less than one millisecond (or may have other values).

The first synchronization preamble is used by the second wireless transceiver for synchronizing- for detecting the reception (by the second wireless transceiver) of the first synchronization preamble. The first synchronization preamble may be a standard compliant synchronization preamble or may differ from a standard compliant synchronization preamble. For example, the first synchronization preamble may comply with the ultra wideband standard.

The length of the first synchronization preamble may be selected to provide a tradeoff between the chances of detecting the first synchronization preamble (which mandates a longer first synchronization preamble) and between energy constraints (which mandate a shorter first synchronization preamble) and/or the length of the first narrowband message. A longer first synchronization preamble may dictate a shorter first narrowband message.

The relationship between a length (bits included in) the first synchronization preamble and the length of the first narrowband message can equal one, may be lower than one or exceed one. The relationship may be define din the initialization step, may be fixed, may change over time, may change based on the condition (especially noise level) of the medium between the first and second wireless transceivers, and the like.

The first narrowband message may include, for example, at least one out of an identifier of the first device, an identifier of the second device and a request (or command) that is aimed to the second wireless device to participate in the ranging process.

The first device may save a first timestamp Tx1 (or any other timing information) about the time of transmission of the first wideband message.

The first wideband message may have an average energy level (or a peak power) that exceeds an average energy (or a peak power) obtained when sending both the first wideband message and the first ranging information over the wideband channel

Step 120, once executed, may increases a coverage range of the first wireless transceiver.

Step 120 may be followed by step 130 of receiving, by the second wireless transceiver, the first wideband message and the first narrowband message.

Step 130 may be followed by step 140 of detecting by the second wireless transceiver the first narrowband message and (in response to the detecting) detecting the first narrowband message.

Either one of step 130 and 140 may include storing a second timestamp (or any other timing information) about the time of reception of the first wideband message by the second wireless transceiver.

Step 140 may be followed by step 150 of generating and transmitting to the first wireless transceiver (i) a second wideband message that consists essentially of a second synchronization preamble and (ii) a second narrowband message that comprises second ranging information and does not include the second synchronization preamble.

The second ranging information may include information about a first time gap (Tgap1) between (i) a time of reception, by the second wireless transceiver, of the first wideband message and, (ii) a time of transmission of the second wideband message.

The second wideband message and the second narrowband messages may be transmitted simultaneously, in a partially overlapping manner or in proximity to each other. The time gap that is considered to be proximate may be predefined and may be, for example, less than one millisecond (or may have other values).

The second synchronization preamble is used by the first wireless transceiver for synchronizing—for detecting the reception (by the first wireless transceiver) of the second synchronization preamble. The second synchronization preamble may be a standard compliant synchronization preamble or may differ from a standard compliant synchronization preamble. For example, the second synchronization preamble may comply with the ultra wideband standard.

The length of the second synchronization preamble may be selected to provide a tradeoff between the chances of detecting the second synchronization preamble (which mandates a longer second synchronization preamble) and between energy constraints (which mandate a shorter second synchronization preamble) and/or the length of the second narrowband message. A longer second synchronization preamble may dictate a shorter second narrowband message.

The relationship between a length (bits included in) the second synchronization preamble and the length of the second narrowband message can equal one, may be lower than one or exceed one. The relationship may be define din the initialization step, may be fixed, may change over time, may change based on the condition (especially noise level) of the medium between the first and second wireless transceivers, and the like.

The second narrowband message may include, for example, at least one out of an identifier of the first device, an identifier of the second device.

The first and second ranging information may include an identifier of the first device and an identifier of the second device.

The first and second synchronization preambles may be equal to each other or may differ from each other.

The first and second wideband messages may be conveyed over ultra wideband carriers.

Step 150 may be followed by step 160 of receiving, by the first wireless transceiver and from the second wireless transceiver, the second wideband message and the second narrowband message.

The first device may save a second timestamp Tr1 (or any other timing information) about the time of reception of the second wideband message.

Step 160 may be followed by step 170 of calculating, by the first device and based on portions of the first and second ranging information, a first estimate of the distance between the first wireless transceiver and the second wireless transceiver.

Assuming that the propagation velocity of the first and second wideband messages is known (for example—the speed of light C), then the first estimate (D1) of the distance between the first and second transceivers may be calculated by the following equation:

D1=Tr1−Tx1−Tgap1/2*C

It should be noted that Tgap1 was calculated by the second device and Tr1 and Tx1 were calculated by the first device. Because the first and second devices are fed by different timing (clock) signals the method 100 may perform additional steps for increasing the accuracy of the estimation of the distance between the first and second transceivers.

Accordingly—step 170 may also be followed by step 180 of sending, by the first wireless transceiver and to the second wireless transceiver, (i) a third wideband message that consists essentially of the first synchronization preamble and (ii) a third narrowband message that comprises third ranging information and does not include the first synchronization preamble.

The third ranging information may include information about a second time gap Tgap2 between (i) a time of reception (Tr1), by the first wireless transceiver, of the second wideband message and, (ii) a time of transmission (Tx2) of the third wideband message.

Step 180 may be followed by step 190 of receiving, by the second wireless transceiver, the third wideband message and the third narrowband message.

Step 190 may be followed by step 200 of detecting by the second wireless transceiver the third narrowband message and (in response to the detecting) detecting the third narrowband message.

Either one of step 190 and 200 may include storing a third timestamp Tr2 (or any other timing information) about the time of reception of the third wideband message by the second wireless transceiver.

Step 200 may be followed by step 210 of calculating, by the second device and based on portions of the second and third ranging information, a second estimate of the distance between the first wireless transceiver and the second wireless transceiver.

Assuming that the propagation velocity of the first and second wideband messages is known (for example—the speed of light C), then the second estimate (D2) of the distance between the first and second transceivers may be calculated by the following equation:

D2=Tr2−Tx2−Tgap2/2*C

The first and second estimates (D1 and D2) of the distance may be received by the first device, by the second device or by another device and may be further processed to generate a third estimate of the distance. The third estimate may be more accurate than each one of the first and second estimates—as it may take into account any clock offsets between the first and second devices.

For example, the third estimate (D3) may be an average of the first and second estimates: D3=(D1+D2)/2. Any other estimate may be calculated.

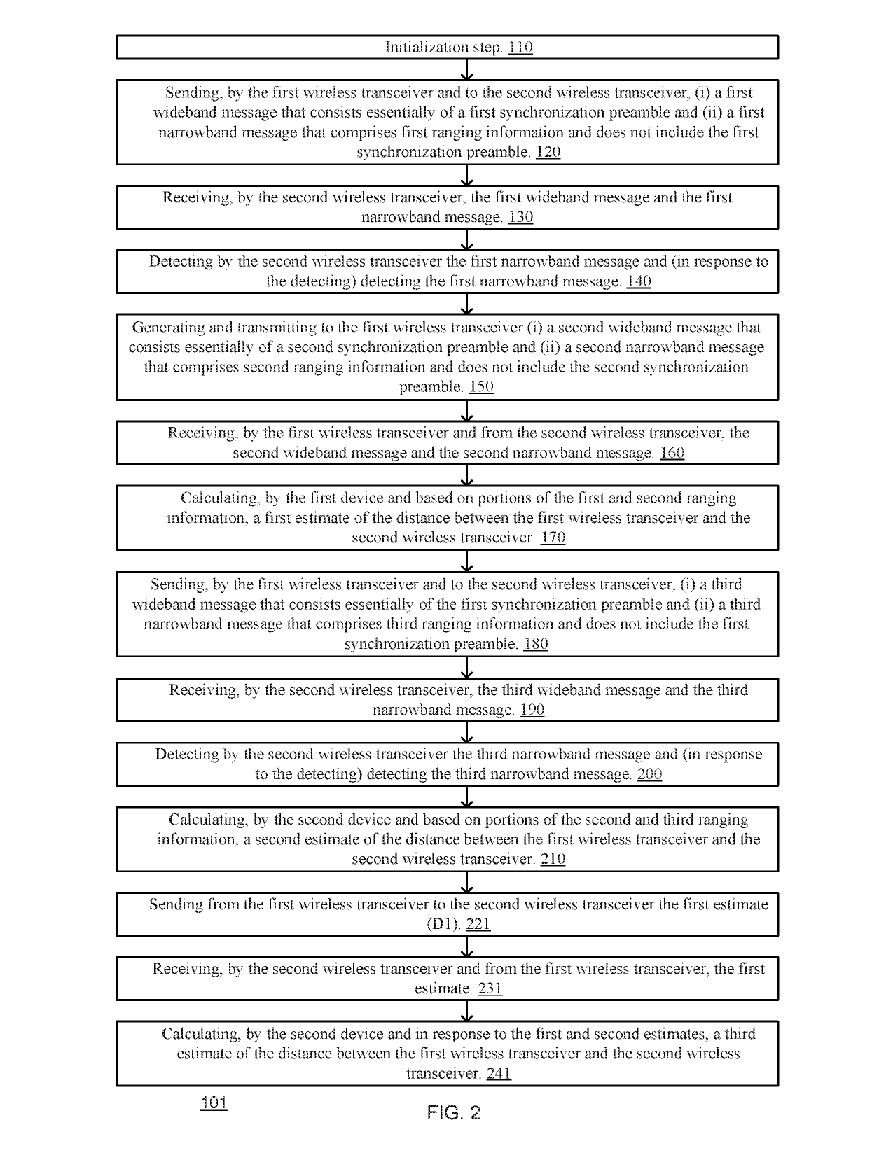

FIG. 1 illustrates a non-limiting example of the options mentioned above—of sending of the second estimate to the first device and the calculating of the third estimate by the first device. FIG. 2 illustrates another non-limiting option—of sending the first estimate to the second device. The second device may then calculate the third estimate.

In FIG. 1 step 210 is followed by step 220 sending from the second wireless transceiver to the first wireless transceiver the second estimate (D2). Step 220 may involve sending only a narrowband message, sending both a wideband message (that consists essentially of the second synchronization preamble) and a narrowband message (that does not include the second synchronization preamble).

Step 220 may include, for example, step 222 of generating and transmitting to the first wireless transceiver (i) a fourth wideband message that consists essentially of the second synchronization preamble and (ii) a fourth narrowband message that comprises fourth ranging information and does not include the second synchronization preamble. The fourth ranging information may include the second estimate.

Step 220 is followed by step 230 of receiving, by the first wireless transceiver and from the second wireless transceiver, the second estimate. Step 230 may include step 202 of receiving by the first wireless transceiver the fourth wideband message and the fourth narrowband message.

Step 230 is followed by step 240 of calculating, by the first device and in response to the first and second estimates, a third estimate of the distance between the first wireless transceiver and the second wireless transceiver.

In order to save power wideband receivers of the first and second wireless transceivers may be closed outside the ranging time windows.

FIG. 2 illustrates method 101 according to an embodiment of the invention. Method 101 differs from method 100 by the calculation of the third estimate by the second device.

Step 210 is followed by steps 221, 231 and 241 (instead of steps 220, 230 and 240 of method 100).

Step 221 may include sending from the first wireless transceiver to the second wireless transceiver the first estimate (D1).

Step 231 may include receiving, by the second wireless transceiver and from the first wireless transceiver, the first estimate.

Step 241 may include calculating, by the second device and in response to the first and second estimates, a third estimate of the distance between the first wireless transceiver and the second wireless transceiver.

Step 221 may include, for example, sending, by the first wireless transceiver and to the second wireless transceiver, (i) a fifth wideband message that consists essentially of the first synchronization preamble and (ii) a fifth narrowband message that comprises a first estimate of the distance between the first wireless transceiver and the second wireless transceiver.

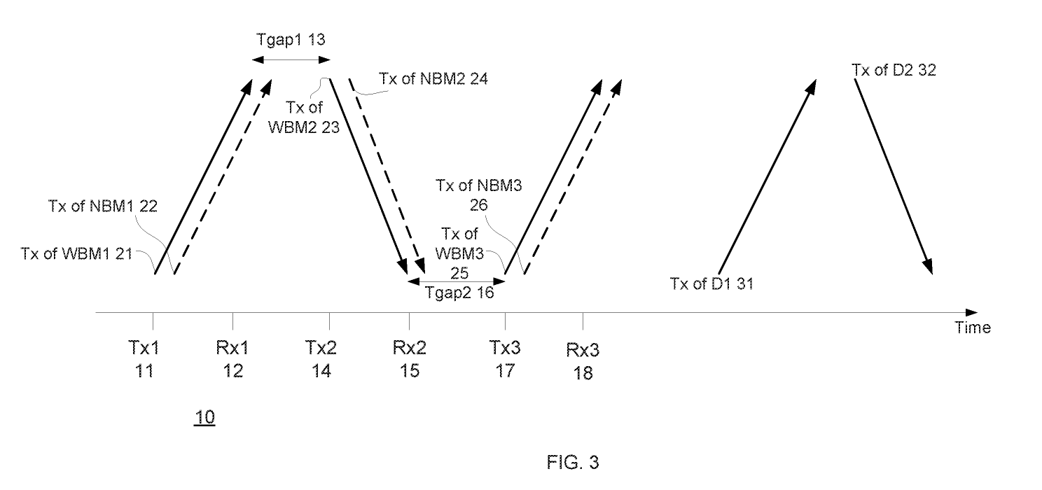

FIG. 3 is a timing diagram 10 according to an embodiment of the invention.

The timing diagram illustrates the following events and time stamps:
a. At Tx1 11 the first wireless transceiver transmits (Tx of WBM1 21) the first wideband message.
b. The first wireless transceiver also transmits (Tx of NWBM1 22) the first narrowband message.
c. At Rx1 12 the second wireless transceiver receives the first wideband message.
d. The second wireless transceiver also receives the first narrowband message.
e. At Tx2 14 the second wireless transceiver transmits (Tx of WBM2 23) the second wideband message. There is a first time gap Tgap1 13 between Rx1 and Tx2.
f. The second wireless transceiver also transmits (Tx of NWBM2 24) the second narrowband message.
g. At Rx2 15 the first wireless transceiver receives the second wideband message.
h. The first wireless transceiver also receives the second narrowband message.
i. At Tx3 17 the first wireless transceiver transmits (Tx of WBM3 25) the third wideband message. There is a second time gap Tgap2 16 between Rx2 and Tx3.
j. The first wireless transceiver also transmits (Tx of NWBM3 26) the third narrowband message.
k. The first wireless transceiver transmits (Tx of D1 31) the first estimate to the second wireless transceiver.
l. The second wireless transceiver transmits (Tx of D2 32) the second estimate to the first wireless transceiver.

It should be noted that step k may be executed in addition to or instead step 1.

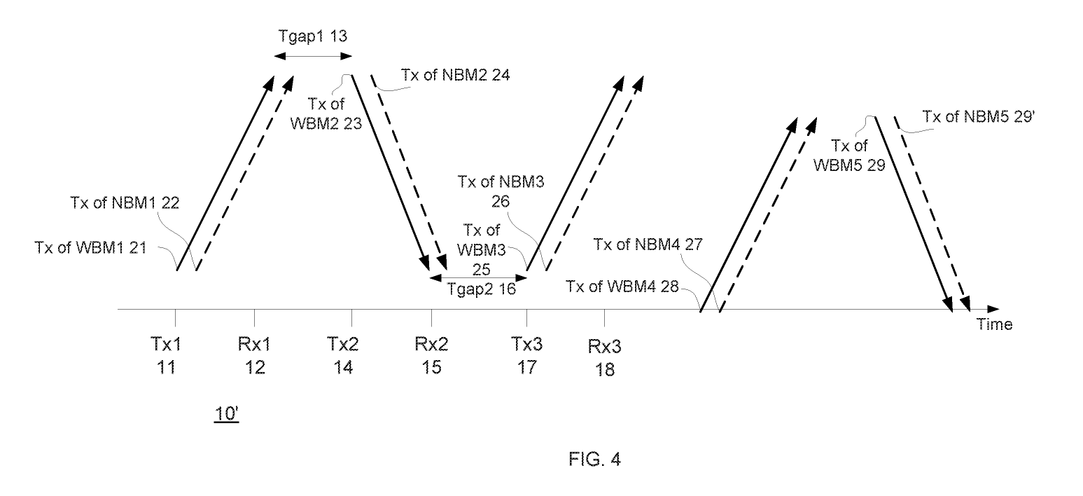

FIG. 4 is a timing diagram 10′ according to an embodiment of the invention.

Timing diagram 10′ differs from timing diagram 10 by:
a. Transmitting (Tx WBM4 27) a fourth wideband message and a fourth narrowband message (Tx NBM4 28) that includes the first estimate.
b. Transmitting (Tx WBMS 29) a fifth wideband message and a fifth narrowband message (Tx NBMS 29′) that includes the second estimate.

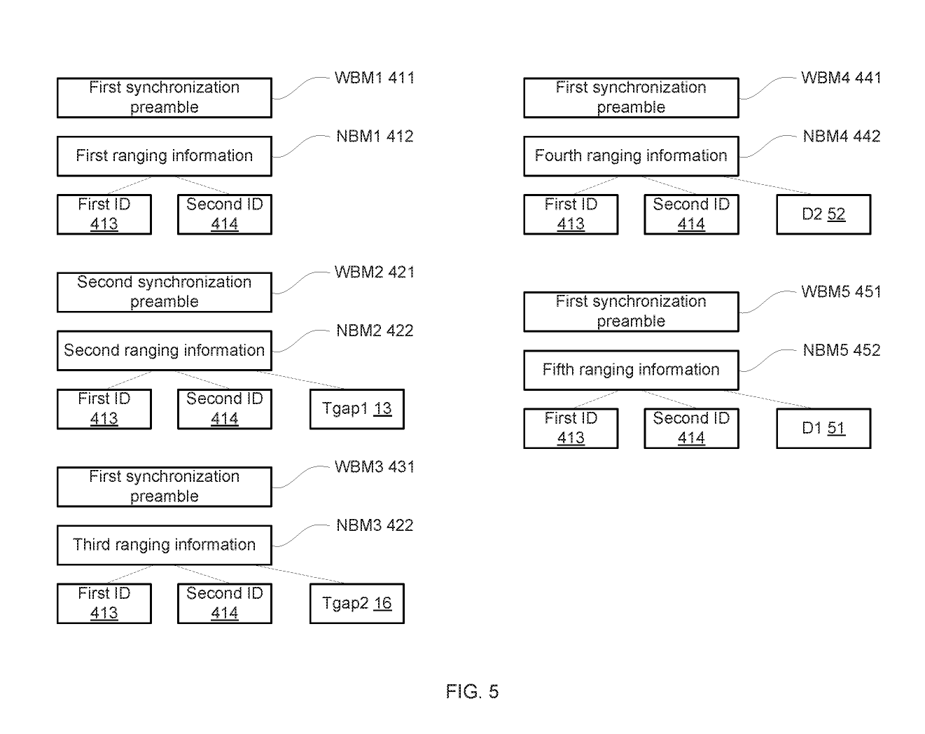

FIG. 5 illustrates various messages according to an embodiment of the invention.

The messages of FIG. 5 include first wideband message WBM1 411, first narrowband message NBM1 412, second wideband message WBM1 421, second narrowband message NBM1 422, third wideband message WBM1 431, third narrowband message NBM1 432, fourth wideband message WBM1 441, fourth narrowband message NBM1 442,fifth wideband message WBM1 451 and fifth narrowband message NBM1 452.

First, third and fourth wideband messages 411, 413 and 414 essentially consist of the first synchronization preamble.

Second and fifth wideband messages 412 and 415 essentially consist of the second synchronization preamble.

The first till fifth narrowband messages 421, 422, 423, 424 and 425 include first till fifth ranging information, respectively.

The first till fifth ranging information may include an identifier (First ID 413) of the first device and an identifier (Second ID 414) of the second device.

The second ranging information may include information about Tgap1 13.

The third ranging information may include information about Tgap2 16.

The fourth ranging information may include second estimate 52.

The fifth ranging information may include first estimate 51.

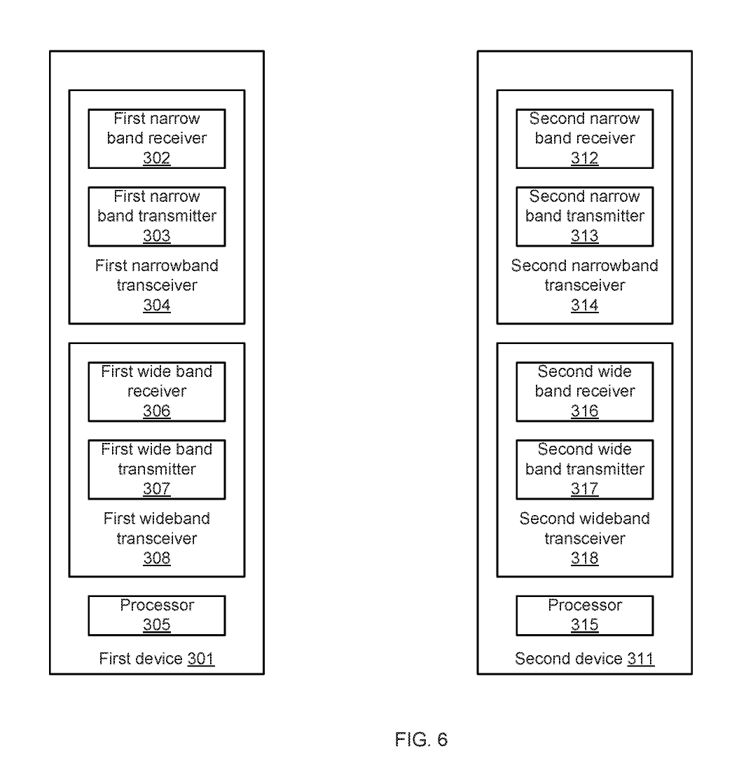

FIG. 6 illustrates the first and second devices 301 and 311 according to an embodiment of the invention.

The first device 301 (may be a mobile device such as a smartphone, a wireless tag and the like) includes processor 305 for calculating the first estimate, first narrowband transceiver 304 and first wideband transceiver 308.

The first narrowband transceiver 304 may include first narrowband receiver 302 and first narrowband transmitter 303.

The first wideband transceiver 308 may include first wideband receiver 306 and first wideband transmitter 307.

The second device 311 (may be a mobile device such as a smartphone, a wireless tag and the like) includes processor 315 for calculating the second estimate, second narrowband transceiver 314 and second wideband transceiver 318.

The second narrowband transceiver 314 may include second narrowband receiver 312 and second narrowband transmitter 313.

The second wideband transceiver 318 may include second wideband receiver 316 and second wideband transmitter 317.

The first and second device may participate in the execution of methods 100 and 101.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD ROM, CD R, etc.) and digital video disk storage media; nonvolatile memory storage media including semiconductor-based memory units such as FLASH memory, EEPROM, EPROM, ROM; ferromagnetic digital memories; MRAM; volatile storage media including registers, memory units or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein may be designed as either negative or positive logic signals. Therefore, in alternate embodiments, those signals described as positive logic signals may be implemented as negative logic signals, and those signals described as negative logic signals may be implemented as positive logic signal.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an ” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements.

The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for determining a distance between a first wireless transceiver of a first device and a second wireless transceiver of a second device, the method comprises:
sending, by the first wireless transceiver and to the second wireless transceiver, (i) a first wideband message that consists essentially of a first synchronization preamble and (ii) a first narrowband message that comprises first ranging information and does not include the first synchronization preamble;
receiving, by the first wireless transceiver and from the second wireless transceiver, (i) a second wideband message that consists essentially of a second synchronization preamble and (ii) a second narrowband message that comprises second ranging information and does not include the second synchronization preamble; and
calculating, by the first device and based on portions of the first and second ranging information, a first estimate of the distance between the first wireless transceiver and the second wireless transceiver.

2. The method according to claim 1, wherein the second ranging information comprises information about a first time gap between (i) a time of reception, by the second wireless transceiver, of the first wideband message and, (ii) a time of transmission of the second wideband message.

3. The method according to claim 1 further comprising sending, by the first wireless transceiver and to the second wireless transceiver, (i) a third wideband message that consists essentially of the first synchronization preamble and (ii) a third narrowband message that comprises third ranging information and does not include the first synchronization preamble.

4. The method according to claim 3, wherein the third ranging information comprises information about a second time gap between (i) a time of reception, by the first wireless transceiver, of the second wideband message and, (ii) a time of transmission of the third wideband message.

5. The method according to claim 3, comprising receiving, by the first wireless transceiver and from the second wireless transceiver, (i) a fourth wideband message that consists essentially of the second synchronization preamble and (ii) a fourth narrowband message that comprises a second estimate of the distance between the first wireless transceiver and the second wireless transceiver; wherein the second estimate was calculated by the second device.

6. The method according to claim 5, comprising calculating, by the first device and in response to the first and second estimates, a third estimate of the distance between the first wireless transceiver and the second wireless transceiver.

7. The method according to claim 3, comprising sending, by the first wireless transceiver and to the second wireless transceiver, (i) a fifth wideband message that consists essentially of the first synchronization preamble and (ii) a fifth narrowband message that comprises a first estimate of the distance between the first wireless transceiver and the second wireless transceiver.

8. The method according to claim 1, wherein the first device is wireless tag reader and the second device is a wireless tag.

9. The method according to claim 1, wherein the sending of the first wideband message and of the first narrowband message is preceded by receiving by the first and second wireless devices information about a timing of a ranging time window that is allocated to the sending of the first wideband message, the first narrowband message, the second wideband message and the second narrowband message.

10. The method according to claim 1, wherein the sending of the first wideband message and of the first narrowband message is preceded by receiving content information that describes a content of the second synchronization preamble; and ignoring the second narrowband message when the second synchronization preamble has a content that differs from the content described in the content information.

11. The method according to claim 1, wherein the first and second ranging information comprises an identifier of the first device and an identifier of the second device.

12. The method according to claim 1, wherein the first and second synchronization messages are equal to each other.

13. The method according to claim 1, wherein the first and second wideband messages are conveyed over ultra wideband carriers.

14. The method according to claim 1, wherein the sending of the first wideband message and of the first narrowband message is preceded by receiving, by the first and second wireless devices, information about a timing of one or more ranging time windows that are allocated to an execution of one or more ranging process; wherein the execution of the one or more ranging processes comprises the sending of the first wideband message, the first narrowband message, the second wideband message and the second narrowband message.

15. The method according to claim 1, comprising closing a wideband reception circuit of the first wireless transceiver outside the one or more ranging time windows.

16. The method according to claim 1, wherein the first wideband message is transmitted over a wideband channel; wherein the first wideband message has an average energy level that exceeds an average energy obtained when sending both the first wideband message and the first ranging information over the wideband channel.

17. The method according to claim 1, wherein the sending of the first wideband and the first narrowband message increases a coverage range of the first wireless transceiver.

18. A non-transitory computer readable medium that stores instructions that when executed by a first device cause the first device to execute the stages of:
sending, by a first wireless transceiver of the first device and to a second wireless transceiver, (i) a first wideband message that consists essentially of a first synchronization preamble and (ii) a first narrowband message that comprises first ranging information and does not include the first synchronization preamble;
receiving, by the first wireless transceiver and from the second wireless transceiver, (i) a second wideband message that consists essentially of a second synchronization preamble and (ii) a second narrowband message that comprises second ranging information and does not include the second synchronization preamble; and
calculating, by the first device and based on portions of the first and second ranging information, a first estimate of the distance between the first wireless transceiver and the second wireless transceiver.

19. A wireless tag that comprises a first wireless transceiver and a processor;
wherein the first wireless transceiver is configured to:
send to the second wireless transceiver (i) a first wideband message that consists essentially of a first synchronization preamble and (ii) a first narrowband message that comprises first ranging information and does not include the first synchronization preamble;
receive from the second wireless transceiver, (i) a second wideband message that consists essentially of a second synchronization preamble and (ii) a second narrowband message that comprises second ranging information and does not include the second synchronization preamble; and
wherein the processor is configured to calculate, based on portions of the first and second ranging information, a first estimate of the distance between the first wireless transceiver and the second wireless transceiver.
